(19) United States
(12) Patent Application Publication
(10) Pub. No.: US 2008/0168976 A1
(43) Pub. Date: Jul. 17, 2008

(54) Adjustable cooking apparatus

(76) Inventor: Keith Simsack, Sanford, MI (US)

Correspondence Address: Technology Law, PLLC, 3595 N. Sunset Way, Sanford, MI, 48657, US

(21) Appl. No.: 11/652,326

(22) Filed: Jan. 11, 2007

(51) Int. Cl. A47J 37/07

(52) U.S. Cl. 126/30

(57) ABSTRACT

A cooking system with lightweight, reinforced cooking surfaces that maybe easily adjusted along a vertical support. The system includes a removable handle which saves space in both storage and in use, and allows adjustment of the cooking surface without the use of protective gloves.

### BACKGROUND OF THE INVENTION

1. Field of the Invention

The present invention involves a cooking apparatus, more particularly: a system of adjustable, lightweight, cooking surfaces and necessary supporting elements primarily intended for outdoor use.

2. Description of Related Art

Outdoor cooking methods and apparatuses have developed over much of human existence, with numerous gratings, spits, and grill surfaces known in the art. Traditionally, much of outdoor cooking has been done over non-adjustable rectangular wire racks, which have the advantage of four leg stability, but have only one cooking temperature option due to their fixed distance from a heat source that can be uneven in temperature due to the inconsistent outdoor burning characteristics of wood, coals, or flammable gases such as propane or methane. Additionally, traditional four legged wire racks cannot easily be removed from the fire to add fuel or to adjust food items while cooking.

Due to these disadvantages, adjustable cooking surface apparatuses have been developed, such as the chain and pin adjustable grill, issued as U.S. Pat. No. 4,094,296 to Beagley, and the setscrew adjustable grill, issued as U.S. Pat. No. 6,006,740 to Ulrickson. More advanced grills that use a sliding cooking surface mounted on a vertical pole such as the Unique Cooking System® and the folding handle grill issued as U.S. Pat. No. 7,004,160 to Bates provide additional range of adjustment. However, all of the single stake supported cooking systems have open grill-style cooking surfaces and permanently affixed handles.

A separate handle has been a long felt need in the field, as users often struggle to avoid burns and easily adjust existing grills. Notably, several grill manufactures conspicuously warn users to use protective gloves to adjust their grills, and in some cases even provide protective gloves with the grill, increasing the cost of the grill. Besides obviating the need for gloves when adjusting the cooking surface, permanently attached handles can cause a significant risk of tripping or bumping, especially while cooking in the dark or dusk or around small children playing or pets. As a permanently affixed handle is by its very nature located near the cooking heat source and can be a tripping hazard that is particularly dangerous, especially for small children. Additionally, depending on design, areas of a permanent handle may become dangerously warm, far from the obvious danger of the heated cooking surface. Moreover, large cooking surfaces with permanently affixed handles are large and bulky, requiring significant amounts of storage space and strength to manipulate them. Although the folding handle grill types reduce storage size, they do nothing to reduce the weight of the cooking surface component. Especially in situations where weight or stowage space is critical, such as travel by small airplane or backpacking, permanently affixed handles are particularly unacceptably large in size and bulky to carry.

Additionally, while solid griddle-style surfaces are preferred for many types of cooking, such as the preparation of eggs, the weight of solid surfaces, such as the traditional cast iron griddle, is quite high. Especially in the single stake cooking systems where the entire mass of the cooking surface is cantilevered from a single stake, the mass of the cooking surface is limited by the surface area of the stake and its depth in the ground. In the existing single stake systems mentioned above, it is impossible to counteract the mass of heavy solid cooking surfaces, and the grills are provided with only wire grate-type racks.

Although thin sheet metal griddle surfaces are prevalent in the indoor cooking prior art; direct and uneven flame heat as used out doors easily warps and distorts steel sheet surfaces, and transmits unevenly though the cooking surface. Besides the practical problem of cooking on a warped surface on which drainage would be uneven, and food items prone to movement, it is possible for a thin sheet steel surface to warp to such an extent as to destroy a cooking apparatus. Currently, there are no single stake, adjustable grilling systems in the market that provide a substantial griddle-style surface due to the warping and weight problems.

### BRIEF SUMMARY OF THE INVENTION

The current invention provides a large and easily adjustable cooking surface while avoiding the disadvantages of previous cooking and grilling systems. Constructed with a reinforced cooking surface, it allows a solid griddle-type surface without the weight problems of traditional cast iron. Compared to existing single stake systems, the invention's winged stake allows greater stability, even with heavy cooking surfaces and/or large overhang distances. The ability to cantilever the cooking surface mass further from the stake due to the designed wings allows for the stake to be positioned more advantageously. Additionally, the removable handle of the current invention alleviates the need for protective gloves and reduces tripping hazards common to existing single stake systems. Thus, this invention provides a cooking apparatus comprised of: a stake member, a reinforced, horizontally oriented cooking surface adjustably positioned on the stake member by an attaching box that uses gravity to bind to the vertical support member, and is adjusted in position by a removable handle.

### BRIEF DESCRIPTION OF THE DRAWINGS

FIG. 1 is a perspective view of a complete cooking apparatus of this invention, with a griddle-type surface, designed in accordance to one embodiment of the present invention.

FIG. 2 is an additional perspective view of the embodiment shown in FIG. 1 illustrating the underside of the cooking surface.

FIG. 3 is a detail view of the underneath of an additional embodiment in which the cooking surface has been machined for increased drainage.

FIG. 4 is a cross-sectional view of one form of handle attachment in which the handle may be affixed to the attachment box and is removable.

FIG. 5 is a cross-sectional view of a method of handle attachment to the outer edge of the grilling surface.

FIG. 6 is top a view of one embodiment of this invention disassembled and packed into an injection molded plastic case.

### DETAILED DESCRIPTION OF THE INVENTION

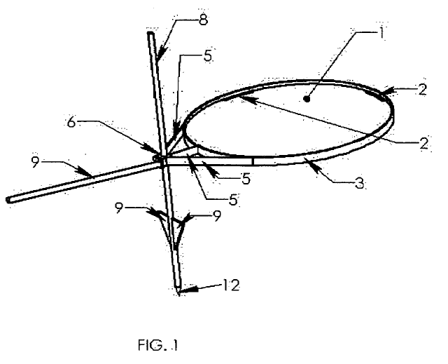

FIG. 1 illustrates one embodiment of the present invention which consists of a griddle type circular sheet metal cooking surface 1 with several drain holes 2. The drain holes 2 in this embodiment are four simple slots positioned at 90 degree intervals along the edge of the cooking surface 1, and are optimized to be smaller than the smallest anticipated cooked food, such that no food will accidentally fall through the cooking surface. Typically the slots should have a width between 0.125″ and 0.625″, though alternative slots or drainage holes could be used, including the possibility of adjustable drainage holes for cooking extremely small foods such as stir-fry noodles. In this embodiment a solid cooking surface 1 has been selected for its advantages in preparing low viscosity foods such as eggs or pancakes, and for small foods such as stir fry dishes. The cooking surface is attached by support members 5 to an attachment box 6, which has a vertical passage 7 of a size to accommodate the vertical stake 8. Although the embodiment illustrated in FIG. 1 has three support members 5 connecting the cooking surface and its reinforcing parts to the attachment box, any means of rigidly connecting the parts would work and be within this invention, including a different number of support members, or even a large horizontal plate.

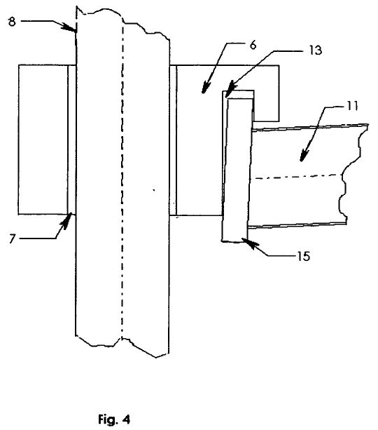

FIG. 4 gives a detail view of the attachment box arrangement, in which the clearance between the stake 8 and the vertical passage 7 is illustrated. In FIG. 4, the relationship of the parts in the attachment box when force has been placed on the handle 11 to counterbalance the mass of the cooking surface and the attachment box 6 is free to move on the stake 8. The clearance between the stake and the passage must be large enough to allow easy movement, even in the presence of minor surface defects or contaminants such as dirt or soot. However, if the clearance is too large, the cooking surface will droop significantly relative to the vertically positioned stake 8, and wear will be increased on the edges of the vertical passage 7. To meet these conditions, the clearance between the stake 8 and the passage 7 should be in the range of 0.050″ to 0.125″ when measured as the difference between the diameter of the stake 8 and the inside diameter of passage 7. When the cooking surface is at rest, the weight of the surface binds the vertical passage 7 in the attachment box to the stake 8, but when the handle 11 is used to counteract the weight of the surface 1, it can be freely moved in both the vertical direction and rotated on the axis of the stake 8. This ability to rotate allows the cooking surface to be removed from the heat source without disturbing the stake's position in the ground. In particular, such a rotation maybe advantageous to adjust the heat source such as adding fuel to a fire, or to clean the cooking surface.

As illustrated in FIG. 4, in this particular embodiment, the lifting handle has an end in the form of a flat plate 15 which can be inserted into corresponding groove 13 on the attachment box 6, directly opposite the cooking surface. Due to the removable nature of the lifting handle, longer handles which would minimize the effort needed to effect cooking surface adjustment are possible. Typically handles would fall into a range from approximately 12 inches to 40 inches in overall length. To promote ease of use, the handle is could be provided with surfaces that aid grasping, such as metal knurling or striation, as well as non-slip coatings and surface treatments. The plate is preferably affixed to the handle 11 at an angle such that when the handle is installed into groove 13, the handle will hang at rest at an upward angle from horizontal. This upward angle is necessary so that mass of the handle binds the plate between groove 13 and the body of the attachment box 6 supporting the handle. As the angle necessary to support the handle is correlated to the surface area of the flat plate 15, and proportional to the mass of the handle, longer handles will require an increased angle. In the alternative, the attachment box maybe fabricated with an angled rear surface, in which case, the plate 15 does not need to be attached at an angle, as gravity will cause the plate 15 to bind on the attachment box's angled surface. If the attachment box is angled, it is possible to construct a handle that is completely symmetrical and does not need a particular side to be inserted first into the attachment box groove.

The attachment box 6 merely makes the distance between the cooking surface 1 and the stake 8 optimized for use over usual campground provided fire rings, typically on the order of about five to ten inches, usually about six inches, which allows the stake to be positioned outside the fire ring. This positioning of the stake 8 outside the fire ring provides advantages of easier installation and removal as well as preventing detrimental effects of high heat from affecting the stake 8. Additionally, this positioning of the cooking surface relative to the stake allows the entire cooking surface to be positioned directly above the heat source in order to allow the maximum usable cooking area. As the stake member has to both rigidly support the cooking surface, and endure repeated insertions into rocky ground, it requires a relatively large diameter rod, preferably in the range of 0.625″ to 2″ diameter. In an embodiment shown in FIG. 1, the stake is provided with a point 12 for enhanced ground penetration. Although non-circular cross-section stakes could be utilized, a cylindrical or ellipsoid cross-section stake has both the ability to easily rotate the cooking surface about the stake axis along with providing a high surface area for binding in the vertical passage 7.

Although a simple solid rod as the stake has economical advantages, construction from tubing, including telescoping or detachable sections is possible, given the same material, increased stake diameter would be needed to have equivalent strength to a solid member. In particular, tubular stake construction is envisioned as giving the possibility of lighter weight, especially when combined with alloy construction.

In the case of a tubular stake, a fabricated point could be installed to prevent stake damage from soil conditions such as rocks. Additionally, a fabricated plug or cover for the upper end of the stake would be advantageous on tubular stakes to prevent deformation from the driving process.

Preferably, the stake 8 is between 24 and 60 inches in overall length, with longer stakes having ergonomic advantages for taller cooks, while shorter stakes have storage space and portability advantages.

The wing members 9 positioned affixed to the stake 8 are preferably sized proportionally to the cantilevered load force of the cooking surface mass. In an embodiment with a 36 inch diameter cooking surface, with a 6″ distance between the stake and the cooking surface, wing members with a surface area of 24 square inches is optimal for average soil conditions. For areas with less dense soils, the wing surface area would be increased, while in more dense soils, the stake member may be provided with a more gradually tapering, hardened point. In this shown embodiment in FIG. 1, the wing members are constructed as triangles and the stake is pointed to allow easy soil penetration. Although other wing designs are certainly possible, such as simple rectangles, triangle style wings offer the advantages of simple construction along with a favorable ratio between difficulty of driving and surface area. Preferably, the wings are attached so their top edge of the wings is between 6″ and 18″ from the point 12 of the stake. The wing members are positioned 180 degrees apart, perpendicular to the centerline of the cooking surface. In this arrangement, the surface area of the wings 9 acts most efficiently to directly opposes the load forces generated by the mass of the entire cooking apparatus. Also, although stakes with more than two wings could be constructed, they would be much more difficult to remove from the ground, as they would resist rocking-type removal motions. By using only two wings, the wing area can be increased as needed to support cooking surface mass without significant penalty in stake removal effort. Although the 180 degree positioned wings allow for simily rocking the stake for removal in most embodiments, a perpendicular handle could be affixed to the stake to aid in removal. Besides the simple expedient of permanently attaching a handle by such means as welding, it is envisioned that a hole could be bored into the handle 11 with a passage large enough to accommodate diameter of the stake 8. To use a removal device of this type, the handle would be lowered onto the stake to any convenient height, much in the manner that attachment box 6 may be positioned on the stake 8. With the handle lowered onto the stake 8 in this manner, the user could lift the stake from the ground by placing their hands on the handle on either side of the stake and lifting in manner that binds the handles passage onto the stake. Adding such a removal feature to handle 11 would not interfere with the handle's primary role in adjusting the cooking surface, and would be economical in manufacturing cost.

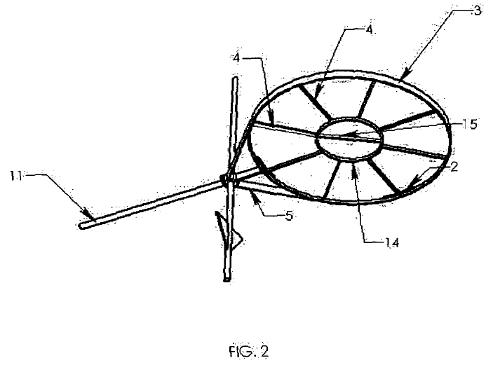

In FIG. 2. the construction of the cooking surface 1 is clearly illustrated with respect to special features intended to promote rigidity. Specifically, the cooking surface 1 resists warping via the combined action of an outer rim 3 about the circumference and radially attached reinforcing members 4 on the underside of the cooking surface. In this embodiment, an inner reinforcing ring 14 is attached to the underside of the cooking surface, and the reinforcing members radiate outwards to the outer rim 3. In this particular embodiment, the inner ring should have a diameter in the range between one half to one quarter the diameter of the outer ring. The length of the reinforcing members 4 is determined by the diameter of the outer and inner rings, as the reinforcing members 4 are affixed to both rings as well as to the underside of the cooking surface. Preferably in this embodiment, the reinforcing members 4 are permanently attached by spots or beads of welding, although other forms of attachment including fasteners that allow disassembly are alternatives. In this particular embodiment, seven equally spaced reinforcing members are used, although alternative embodiments incorporating more or less members are possible. Equally spacing of the reinforcing members 4 allows for the maximum amount of cooking surface warpage resistance; however, construction with alternative spacing is possible as an alternative embodiment. An additional central support member 15 is located across the inner ring 14, which facilitates easy fabrication as well as providing additional stability to the assembled cooking apparatus.

FIG. 4 is a detailed, cross-sectional illustration of the handle attachment style also shown in FIG. 1. In this embodiment, the handle end is a simple thin metal plate 15 that is affixed to the handle body 11 by means such as welding. The plate is sized such that it engages a groove 13 in the attachment box 6. Downward force on the handle counteracts the weight of the cooking surface 1, such that the cooking surface 1 maybe adjusted. In most typical use, a user would place both hands on the handle, press down on the rear of the handle to release the binding of the cooking surface's weight on the stake member, and simultaneously lift or lower the entire cooking surface by pushing upwards or downwards with the other hand on portion of the handle closer to the cooking surface. If for some reason the user slips or lets go of the handle the cooking surface will bind to the stake member in its current position. Unlike competing adjustment systems, there is no possibility of the cooking surface plummeting into the fire, or moving suddenly when released. Preferably the handle is only connected to the attachment box when the user is actively adjusting the grill; however, the handle is constructed with a fit such that it will remain on the grill's attachment box by virtue of the handle mass binding the plate 15 in the attachment box groove 13. Although the surfaces of the attachment box 6 certainly become warm, the handle itself remains cool do to the limited amount of time it is in contact with the heated surfaces of attachment box 6 or rim 3 during grill adjustment. Certainly handle construction techniques that minimize even this brief heat transfer are possible, such as the addition of air gaps or insulating materials between the grasping portions of the handle and the portions of the handle that contact the heated grill surface are possible.

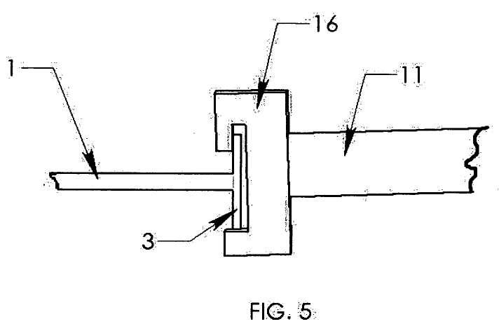

FIG. 5 shows a cross-sectional view of an alternative form of handle attachment, in which the handle 11 can be affixed to any point on the outside rim 3 of the cooking surface by means of a machined or fabricated grasping box 16. Rather than connecting to the. attachment box 6, the handle in this embodiment connects directly to the outer rim 3. To use this style of handle, the handle 11 would be tilted upwards as to allow the upper edge of the outer rim 3 to enter the grasping box 16 at an angle. Since the machined groove in the grasping box has a greater vertical dimension than that of the outer rim 3, the handle 11 can be slid vertically upwards relative to the outer rim 3 until the upper edge of the rim 3 is resting on the upper shelf of the grasping box 16. At the point where the grasping box 16 has engaged the rim, the handle can hang from the rim unattended, or be moved radially around the rim. By lifting the handle 11, it is possible to lift the cooking surface, and in turn release the binding between the attachment box 6 and the stake 8, which allows adjustment of the cooking surface. This type of handle attachment would not be exclusive of other means disclosed as it could be merely attached to the opposite end of the handle which is illustrated in FIG. 1.

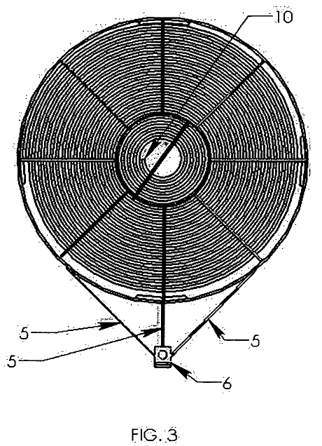

In another embodiment, as illustrated by FIG. 3, the cooking surface takes a more open grate form, with a spiral track 10 milled through the top of the cooking surface. Besides a spirally machined track, various patterns of holes or slots could be used in the alternative. Although griddle type surfaces as illustrated in FIG. 1 has advantages when cooking low viscosity foods such as pancakes or eggs, surfaces with increased drainage may be preferred for health benefits such as increased oil drainage, which can reduce the total fat content of cooked foods. Additionally, open grate surfaces have the advantage of allowing more flavors from fire-type heat sources to be imparted to the cooking foods. Although a surface made by ventilating a solid sheet is illustrated, and alternative and similar construction fabricated from wire would be possible, and would result in lower material costs. Also, cooking surfaces that are various combinations of open grate like surfaces and griddle like surfaces are possible, such as to allow cooking with both surface types simultaneously.

In the embodiments previously discussed, unless separately discussed, all portions of the invention are preferably fabricated from SAE 1018 or 1020 steel via welding, with or without coatings to prevent corrosion and to provide anti-stick properties for cooking purposes. Alternatively, any rigid material resistant to temperatures used in cooking would be suitable for construction, such as various iron, steel, aluminum, copper, titanium, or nickel metals, as well as heat resistant ceramics. In particular, lightweight construction from aluminum or titanium alloy has possible advantages for uses where weight is extremely critical. Additionally, embodiments constructed from layered metals, or combinations of metals and ceramic coatings may provide superior cooking properties. Although simple welded assembly is extremely cost effective, alternative embodiments constructed by other fabrication means such as casting or extrusion are certainly possible, especially for constructions with non-ferrous alloys.

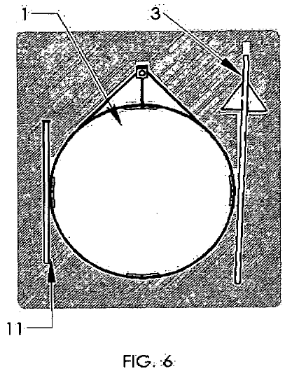

One of the major features of the present invention is the relative portability compared to competing designs. FIG. 6 illustrates the portability of the cooking apparatus, with a top view of one embodiment of the entire apparatus disassembled in a one half of a clamshell-style injection molded plastic carrying case. FIG. 6 shows an apparatus with a 36″ diameter cooking surface, and it is apparent from FIG. 6 that the solid stake 8 is the longest item in the apparatus causing the case dimensions for a 36″ cooking surface apparatus of the illustrated embodiment to be approximately 46″×51″ and less than 2″ thick.

Although the invention has been described with reference to its preferred embodiments, those of ordinary skill in the art may, upon reading and understanding this disclosure, appreciate changes and modifications which may be made which do not depart from the scope and spirit of the invention as described above or claimed hereafter.

What is claimed is:

1. A cooking apparatus comprised of:
a stake member, a reinforced, horizontally oriented cooking surface adjustably positioned on the stake member by an attaching box that uses gravity to bind to the vertical support member, and is adjusted in position by a removable handle.

2. The apparatus in claim 1, with vertically oriented flanges on the stake member.

3. The apparatus in claim 1 with a cooking surface comprising of a flat plate area with a reinforcing rim affixed around its circumference.

4. The apparatus of claim 1 with a cooking surface reinforced by radially positioned members on the lower face.

5. The apparatus of claim 1 with a handle that attaches to the rim of the cooking surface.

6. The apparatus of claim 1 in which the removable handle may be affixed to the attachment means of the apparatus.

7. The apparatus of claim 1 with two vertically oriented flanges on the stake member that are positioned 180 degrees apart and are shaped in a form to reduce the effort necessary to drive the support member into soil by providing a minimal soil contact area in the vertical plane.

8. The apparatus of claim 1 in which the vertically oriented flanges are constructed in a triangular wing shape in order to provide a minimal soil contact area in the vertical plane.

9. The apparatus of claim 1 in which the removable handle can be attached directly to the stake in order to aid in removing the stake from the ground.
